(19) United States
(12) Patent Application Publication
(10) Pub. No.: US 2020/0214325 A1
(43) Pub. Date: Jul. 9, 2020

(54) Protein Supplement System

(71) Applicant: Christopher Bratt, Twin Falls, ID (US)

(72) Inventor: Christopher Bratt, Twin Falls, ID (US)

(21) Appl. No.: 16/821,809

(22) Filed: Mar. 17, 2020

Related U.S. Application Data
(62) Division of application No. 15/673,201, filed on Aug. 9, 2017.
(60) Provisional application No. 62/372,693, filed on Aug. 9, 2016.

(51) Int. Cl. A23L 2/66; A23L 2/52; A23L 33/16; A23L 33/17; A23L 33/15; A23L 33/19

(52) U.S. Cl. CPC A23L 2/66; A23L 2/52; A23L 33/16; A23L 33/17; A23V 2250/70; A23L 33/19; A23V 2002/00; A23V 2250/06; A23V 2250/15; A23L 33/15

(57) ABSTRACT

What is disclosed is a protein supplement drink mix comprising at least one base protein powder and a plurality of separately packaged second components, each second component having at least one different active ingredient pre-selected for the physiological needs regarding a pre-determined activity, age, and/or gender demographic. The first component and the second component are mixed generally with a liquid to provide a base for a protein drink, although a liquid can form a portion of the first component or second components.

### PRIORITY/CROSS-REFERENCE TO RELATED APPLICATIONS

This application is a divisional application of U.S. patent application Ser. No. 15/673201, filed on Aug. 9, 2017 and claims the benefit of U.S. Provisional Application No. 62/372693, filed Aug. 9, 2016 the disclosure of which is incorporated by reference.

### DISCLOSURE

### Background Information

The protein powder supplement industry typically provides protein powder that has flavor provided by the manufacturer without the ability of the consumer to vary the flavor. These protein powders typically contain only protein products and byproducts, flavor, and food grade products intended to assure freshness. As it stands now, nearly every protein powder in the market provides a month's supply of product if taken in the quantity suggested by the manufacturer. However, these suggested servings are just that, suggestions. Customers will be able to use more or less product without fear of overdosing or losing the effectiveness of the product. So for the customer that takes two protein shakes a day with only having one flavor the monotony of the drinks becomes boring and undesirable.

### Disclosure of the Inventive Concepts

The invention is directed to a protein mix that can be sold as two or more components. The base component is a base protein component that preferably is configured at a targeted group of consumers. In the preferred embodiment there can be several lines of base protein. Each base protein line can be formulated towards a different group, such as, but not limited to, elderly people, active people, young people, teenagers, middle-aged people, men, women, different age categories of men and/or women. The base protein line will be of a configuration that is beneficial to that group. Each of the different second component associated with each individual first component then provides the ability to alter the finished drink product. The second components thus are separately packaged (meaning they are not mixed with the base protein line). This includes providing a second component formulated, for example, morning drinks, afternoon drinks, evening drinks, post work out drinks, pre-workout drinks, anaerobic exercise based drinks, aerobic exercise based drinks, long distance running drinks, meal replacement drinks. Each of these drinks can be formulated with a wide variety of active ingredients that are directed and/or known to enhance specific activities. For example, a component directed toward an elderly person may have increased levels of calcium, glucosamine, chondroitin, or other nutritional supplement aimed at providing ideal supplements toward an elderly person. Each of the different second components can be directed toward a different activity, different time, or different need of the user. The claims of this patent application are directed specifically to these separate (non-mixed) first component and second component. This provides an end user with the ability to purchase the base line of product, then to purchase separately a powder, gel, or liquid second component that is specifically marketed to be mixed with the first component. For example, the second component can be a powder, gel or liquid that is formulated for pre-workout, post workout, pre aerobic workout, post aerobic workout, pre anaerobic workout, post anaerobic workout (such as weightlifting), or can be formulated toward specific sporting events. The formulation means that the active ingredients are utilized to target these specific groups. The first component and second component are mixed with a fluid (called the base fluid in some embodiments), such as water or milk, to provide the final product. Alternatively the first component could be sold as a fluid, with the second component to be added thereto.

Alternatively, a different line of base protein can be provided and directed toward a different user group. For example, a base protein that is directed toward a young (such as mid 20s) user who is engaged in weight lifting can be formulated. Similarly, a user who is into more aerobic activities such as running, cycling, or swimming could be formulated, for example. Alternatively, the base product could be a wide spectrum based protein or protein mix. Alternatively, the second component variations could include the same active ingredients but in different concentrations. A sample potential dry protein powder component (component 1) is shown in Table 1. The first component includes a protein blend that includes Micellar Whey, Whey Protein Concentrate, Whey Protein Isolate, and Whey Protein Isolate 97% Whey Protein Hydrolysate, Cocoa Powder (processed with alkali), natural and artificial flavors, Maltodextrin, Gum Blend (Cellulose Gum, Xanthan Gum, Carrageenan), Salt, Soy Lecithin, Sucralose, Acesulfame Potassium.

While many different embodiments of the inventive concepts are considered, a sample powder and/or gel component (component 2) is shown in Table 2. The second component includes Dextrose, Natural and artificial flavors, Calcium Silicate, Sucralose, Acesulfame Potassium, FD&C red #40, Soy Lecithin, Cellulose, Stearic Acid, Croscarmellose Sodium, Vegetable Stearate, Silicon Dioxide, Sorbitol, Modified Cellulose Gum, Colloidal Silicon Dioxide and Magnesium Stearate.

Part 1 (the first component) is the powdered protein component which may or may not include the following: any type and number of powdered protein(s) that combine to provide supplemental nutritional benefits to the consumer whether real or perceived that can and do enter the body through oral consumption when it enters solution with a base liquid such as water, milk, or other liquid and is then consumed orally. The first component can and will vary based on who the product is intended for, but will always include as its major component, protein.

Other items that may be included in the first protein component would be material commonly used to keep the protein from clumping, preservatives, cover flavors, flavors etc. The first component may also include material, either organic or synthetic that gives the product a particular texture or feeling while being consumed (like some items can be added to make the product feel creamier).

In a preferred embodiment the powdered protein component (the first component) is made up of at least one protein with other ingredients. Alternatively a mixture of various proteins can be used as the protein of the first component. This can include any different number of animal, plant, insect, or other protein and still be within the inventive concepts disclosed herein. In a preferred embodiment, the first component will include a blend of two (2) or more proteins that each burn at different rates in the human body. The blending of different proteins allows for a different uptake (absorption) by the human body. The different protein uptake rates can vary from fast to slow depending on the intent behind the formulation of the product. For example, in a three protein system, the first protein will have a fast uptake, the second will be a midrange uptake and the final version will have a longer duration. In a preferred embodiment, the first component will also contain masking flavors. These neutral flavors will cover the otherwise bitter flavors that are typically associated with various proteins. The first component will also have a component of powdered product that will swell in the human stomach when mixed with water or other fluid. This will give the customer a full feeling and provide a sense of satisfaction after taking the product. In a preferred embodiment, the first component will also include an anti-clumping/anti-coagulating agent so the powder does not cake together.

The second component in a preferred embodiment is a liquid, gel and/or powder component. The second component may include any number of specific vitamin(s) and/or minerals including, but not limited to: Vitamin A, Thiamin (B1), Riboflavin (B2), Niacin (B3), Pantothenic Acid (B5), Vitamin B6, Vitamin B12, Biotin, Vitamin C, Choline, Vitamin D, Vitamin E, Folic Acid, Vitamin K, all minerals, Calcium, Chloride, Chromium, Copper, Fluoride, Iodine, Iron, Magnesium, Manganese, Molybdenum, Phosphorus, Potassium, Selenium, Sodium, Sulfur, Xinc, Amino Acids (many forms). There may be an additional nutritional supplement which may include, but not limited to: Tea-Crine, Caffeine, Alfa-GPC, Lactoferrin, or any other specific nutritional matter, organic or synthetic that would aid in supplying a supplemental supply of a given specific product(s) that aid in physical or mental growth, recovery, or repair whether actual or perceived. The second component also contains any natural of artificial flavor and its components.

In a preferred embodiment the second component can be in the form of a powder to mix with the first component. This powder component can be manufactured to contain any variety of active ingredients that can be formed into a powder. In an alternate preferred embodiment the second component in the form of a gel or powder will be made up of a product that is viscous and mixes easily with a base liquid (including, but not limited to, water or milk) that easily suspends (or holds) other products in its solution. In an embodiment in which the second component includes a gel base, the gel base will have suspended therein a multivitamin active ingredient, such as a bolus of B12, caffeine and any other product that may be used to complete the product for a specific demographic. In a preferred embodiment, electrolytes, theacrine, glucosamine and chondroitin, fiber and a variety of ingredients used for ocular health may be included in the second component. In a preferred embodiment, the second component will also contain the flavor. A plurality of second components will be offered for combining with the first component. The first component and said second component(s) are packaged separately. This allows for a user to select a different second component depending on the flavor choice of the user and/or the desired active ingredient. This allows the user to obtain a bulk or large amount of the primary component and to select different second components for variety.

The disclosure includes a method of mixing a protein drink from two or more components, wherein the first component, discussed above, is added to given amount of liquid, which is typically considered a recommended size of liquid—most likely 9 or more ounces of water as is common in the art—the powder(s) dissolve or otherwise become suspended in solution. Once suspended, the customer will add the second component (such as a powder or gel solution) and thereby add the additional nutritional ingredients and the flavor. It is thought that any amount of liquid sufficient to disperse/dissolve the powder or gel in the liquid can be used and still fall within the inventive concept disclosed herein. One purpose of the invention is to provide a base protein to which different active ingredients (found in the second component) are added.

In a preferred embodiment there can be several lines of base protein. Each base protein line can be formulated towards a different group, such as, but not limited to, elderly people, active people, young people, teenagers, middle-aged people, men, women, different age categories of men and/or women. Each of the different second components associated with each individual first component then provides a different drink. This includes providing a second component formulated, for example, morning drinks, afternoon drinks, evening drinks, post work out drinks, pre-workout drinks, anaerobic exercise based drinks, aerobic exercise based drinks, long distance running drinks, meal replacement drinks. Each of these drinks can be formulated with a wide variety of active ingredients that are directed and/or known to enhance specific activities. For example, a component directed toward an elderly person may have increased levels of calcium, glucosamine, chondroitin, or other nutritional supplement aimed at providing ideal supplements toward an elderly person. Each of the different second components can be directed toward a different activity, different time, or different need of the user. Alternatively, or in addition, the second components can be formulated to vary in flavor.

Similarly, a different line of base protein can be provided and formulated for a different user group. For example, a base protein that is directed toward a young (such as mid 20s) user who is engaged in weight lifting can be formulated. Similarly, a base protein for a user who is into more aerobic activities such as running, cycling, or swimming could be formulated, for example. Alternatively, the base product could be a wide spectrum base formulation including one or more specifically selected proteins. The second component variations could include the same active ingredients but in different concentrations. A sample potential dry protein powder component (component 1) is shown in table 1. The first component includes a protein blend that includes Micellar Whey, Whey Protein Concentrate, Whey Protein Isolate, and Whey Protein Isolate 97% Whey Protein Hydrolysate, Cocoa Powder (processed with alkali), natural and artificial flavors, Maltodextrin, Gum Blend (Cellulose Gum, Xanthan Gum, Carrageenan), Salt, Soy Lecithin, Sucralose, Acesulfame Potassium.

A sample powder/gel component (component 2) is shown in table 2. The second component includes Dextrose, Natural and artificial flavors, Calcium Silicate, Sucralose, Acesulfame Potassium, FD&C red #40, Soy Lecithin, Cellulose, Stearic Acid, Croscarmellose Sodium, Vegetable Stearate, Silicon Dioxide, Sorbitol, Modified Cellulose Gum, Colloidal Silicon Dioxide and Magnesium Stearate.

TABLE 1
Dry Protein Powder Component (Part 1)

Serving Size: 1 Scoop (35 g)
Servings Per Container: Approx. 28
Amount Per Serving % DV
Calories 140
Calories from Fat 20
Total Fat 2 g 3%*
Saturated Fat 1.5 g 8%*
Cholesterol 75 mg 25%
Total Carbohydrate 4 g 1%*
Sugars 2 g †
Protein 25 g 50%*
Calcium 168 mg 17%
Iron 2.1 mg 12%
Sodium 180 mg 8%

Ingredients:

Protein Blend (Micellar Whey, Whey Protein Concentrate, Whey Protein Isolate, Whey Protein Isolate 97% Whey Protein Hydrolysate), Cocoa Powder (Processed With Alkali), Natural and Artificial Flavors, Maltodextrin, Gum Blend (Cellulose Gum, Xanthan Gum, Carrageenan), Salt, Soy Lecithin, Sucralose, Acesulfame Potassium.

TABLE 2
Powder/Gel Component (Part 2)

Serving Size: Unknown (can probably say 3.0 fl oz. for the gels)
Servings Per Container 28
Amount Per Serving % DV
Calories 15
Total Carbohydrates 4 g 1%*
Sugars 2 g †
Sodium (as sodium chloride) 220 mg 9%
Creatine Hydrochloride 2 g †
CarnoSyn ® Beta-Alanine 2 g †
Betaine (Trimethylglycine) 1.5 g †
Taurine 1 g †
N-Acetyl L-Cysteine 600 mg †
AlphaSize ® Alpha-Glyceryl
Phosphoric Choline 300 mg †
Citrulline Malate 6 g †
Beta vulgaris L. (beet extract) 500 mg †
L-Leucine 3 g †
L-Isoleucine 1.5 g †
L-Valine 1.5 g †
L-Tyrosine 1.5 g †
Caffeine Anhydrous 300 mg †
Huperzine A 50 mcg †
Bioperine ® (Piper Nigrum Fruit Extract) 5 mg †
Vitamin A (Beta Carotene, Acetate) 5000 IU 100%
Vitamin C (Ascorbic Acid) 150 mg 250%
Vitamin D2 400 IU 100%
Vitamin E (D-Alpha Tocopherol) 50 IU 167%
Vitamin B1 (Thiamine Mononitrate) 12.5 mg 833%
Vitamin B2 (Riboflavin) 12.5 mg 735%
Vitamin B3 (Niacinimide, Niacin) 50 mg 250%
Vitamin B6 (Pyridoxine HCL) 12.5 mg 625%
Folic Acid 400 mcg 100%
Vitamin B12 100 mcg 1666%
Biotin 75 mcg 25%
Vitamin B5 (D-Calcium Pantothenate) 25 mg 250%
Calcium (Calcium Phosphate,]
Carbonate) 100 mg 10%
Iodine (Kelp) 150 mcg 100%
Magnesium (Oxide) 40 mg 10%
Zinc (Oxide) 9 mg 60%
Selenium 70 mcg 100%
Copper (Gluconate) 200 mcg 10%
Manganese (Sulphate) 2 mg 100%
Chromium 120 mcg 100%
Molybdenum 75 mcg 100%
Boron (Citrate) 1 mg *
Choline (Bitartrate) 30 mg *
Inositol (Nicotinate) 30 mg *
Lutein 50 mcg *
PABA 12.5 mcg *
Citrus Bioflavonoids 10 mg *
Pectin 10 mg *
Betaine HCL 10 mg *
Alfalfa (Leaf) Medicago Sativa 5 mg *
Chamomile (Leaf) Matricaria Recutita 5 mg *
Rose Hips Rosa Canina 5 mg *
Rutin 12.5 mg *
Parsley (Leaf) Petoselinum Sativum 5 mg *
Acerola Extract Malphighia Garb 500 mcg *
Vitamin A (As Beta-Carotene) 5,000 IU 100%
Vitamin C (As Ascorbic Acid) 250 mg 417%
Niacin amide 50 mg 250%
Vitamin B-6 (As Pyridoxine HCL) 12 mg 600%
Zinc (As Zinc Citrate &
Monomethionine) 1.5 mg 100%
Selenium
(As L-Selenomethionine & Sodium
Selenite) 100 mcg 143%
Copper (As Copper Sebacate) l mg 50%
Manganese (As Manganese Citrate) 10 mg 500%
Molybdenum (As Molybdenum Chelate) 130 mcg 173%
MSM (Methylsulfonylmethane
[OptiMSM ®]) 1.125g †
Glucosamine Sulfate
(As Glucosamine Sulfate
Potassium Chloride) 900 mg †
Boswellia Serrata Extract Yielding
273 Mg Boswellic Acids 321 mg †
Quercetin 150 mg †
Horse Chestnut Seed Extract
Yielding 20 Mg Aescin 100 mg †
Turmeric Rhizome Extract
Yielding 95% Curcumin 50 mg †
Stinging Nettle Leaf Extract
(1% Silicic Acid) 50 mg †
Ashwagandha Root Extract (5:1) 50 mg †
N-Acetyl Cysteine 50 mg †
Sea Cucumber 40 mg †
Grape Seed Extract (Proanthodyn ™)
With A Procyanidolic Value Of 95 25 mg †
Aloe Vera Whole Leaf Concentrate 25 mg †
Black Pepper Fruit Extract
(Bioperine ®) 1 mg †

† Daily Value not established

Other Ingredients:

Dextrose, Natural and artificial flavors, Calcium Silicate, Sucralose, Acesulfame Potassium, Fd&C Red #40,and Soy lecithin. Cellulose, Stearic Acid, Croscarmellose Sodium, Vegetable Stearate, Silicon Dioxide. (All Of The Ingredients Are From Plant Or Mineral Sources) Stearic Acid, Sorbitol, Modified Cellulose Gum, Colloidal Silicon Dioxide, And Magnesium Stearate.

Contains Shellfish (Shrimp and Crab) and Soy.

Contains No Yeast, Dairy, Egg, Gluten Or Wheat. Contains No Sugar, Starch, Salt, Preservatives, Or Artificial Color, Flavor Or Fragrance.

What is claimed is as follows:

1. A protein supplement drink mix system, said drink mix system comprising:
a prepackaged first component, said first component comprising a dry protein powder comprising at least one base protein, wherein said first component is formulated toward a different demographic group;
a plurality of separately packaged second components wherein each of said second components is packaged separately from said first component in a premixed state, wherein said second components comprise at least one different active ingredient variation between said second components to provide a plurality of options for different active ingredient to be mixed with said first component, wherein said second components are specifically configured with at least one different active ingredient is selected for the physiological needs of a consumer group regarding a pre-determined activity of said demographic group, wherein said second component is selected from the group consisting of a powder, a liquid or a gel;
wherein said first component is configured to be mixed with said plurality of second components and a base liquid to provide a protein supplement drink.

2. The protein supplement drink mix of claim 1, wherein said first component comprises a plurality of first components, wherein each of said first components comprises a different protein formulation.

3. The protein supplement drink mix of claim 1, wherein said first component is configured for a demographic of user selected from the group consisting of teenaged persons, middle aged persons, and elderly persons.

4. The protein supplement drink mix of claim 1, wherein said plurality of second components are configured to provide a first flavor when a first second component is mixed with said first component and to provide a second flavor when a second second component is mixed with said first component.

5. The protein supplement drink mix of claim 1, wherein said at least one active ingredient is selected from the group consisting of Vitamin A, Thiamin (B1), Riboflavin (B2), Niacin (B3), Pantothenic Acid (B5), Vitamin B6, Vitamin B12, Biotin, Vitamin C, Choline, Vitamin D, Vitamin E, Folic Acid, Vitamin K, Calcium, Chloride, Chromium, Copper, Fluoride, Iodine, Iron, Magnesium, Manganese, Molybdenum, Phosphorus, Potassium, Selenium, Sodium, Sulfur, Xinc, and an Amino Acids.

6. The protein supplement drink mix of claim 1, wherein said first component consists essentially of three different proteins, wherein a first protein comprises a fast uptake protein, wherein a second protein comprises a slow uptake protein, and wherein a third protein comprises an uptake rate between said fast uptake protein and said slow uptake protein.

7. The protein supplement drink mix of claim 1, wherein said second components comprise a series of active ingredient configured for improving the athletic capability of a user, wherein each of said different second components is configured for improving the athletic capability of a user for a different athletic activity.
